(19) United States
(12) Patent Application Publication
(10) Pub. No.: US 2008/0080382 A1
(43) Pub. Date: Apr. 3, 2008

(54) Refined Assured Forwarding Framework for Differentiated Services Architecture

(76) Inventors: Mostafa H. Dahshan, Riyadh (SA); Pramode Verma, Tulsa, OK (US); James J. Sluss JR., Broken Arrow, OK (US)

Correspondence Address: DUNLAP CODDING & ROGERS, P.C., PO BOX 16370, OKLAHOMA CITY, OK, 73113, US

(21) Appl. No.: 11/864,311

(22) Filed: Sep. 28, 2007

Related U.S. Application Data
(60) Provisional application No. 60/847,885, filed on Sep. 28, 2006.

(51) Int. Cl. H04L 12/56

(52) U.S. Cl. 370/235

(57) ABSTRACT

The DiffServ architecture is an increasingly preferred approach for providing varying levels of Quality of Service in an IP network. This discovery presents a new framework for improving the performance of the DiffServ architecture where heterogeneous traffic flows share the same aggregate class. The new framework requires minimal modification to existing DiffServ routers by adding a second layer of classification of flows based on their average packet sizes and using Weighted Fair Queueing for flow scheduling. The efficiency of the new framework is demonstrated by simulation results for delay, packet delivery, throughput, and packet loss, under different traffic scenarios.

### CROSS-REFERENCE TO RELATED APPLICATIONS

The present patent application claims priority to the provisional patent application identified by U.S. Ser. No. 60/847,885, filed on Sep. 28, 2006, the entire content of which is hereby incorporated herein by reference.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### REFERENCE TO A “SEQUENCE LISTING,” A TABLE, OR A COMPUTER PROGRAMMING LISTING APPENDIX SUBMITTED ON A COMPACT DISC AND AN INCORPORATION-BY-REFERENCE OF THE MATERIAL ON THE COMPACT DISC

Not Applicable.

### BACKGROUND OF THE INVENTION

1. Introduction

The Internet was designed as a best effort network for transporting computer-to-computer traffic. However, as the footprint of the Internet grew, a wide variety of applications emerged. The growth in the diversity and volume of Internet applications made it essential to discover and implement new techniques that support different levels of service for different classes of traffic. These techniques are collectively referred to as Quality of Services (QoS) techniques. They are generally classified into micro-level or fine grained techniques and macro-level or coarse grained techniques [1]. Micro level techniques operate at the flow level. Routers keep track of the status of each flow during the connection lifetime. This results in a better service quality but involves design complexities and processing overhead [2]. Macro level techniques attempt to overcome these complexities by operating at a higher aggregate or class level rather than on the flow level. The Integrated Services (IntServ) architecture is an example of micro-level techniques. In IntServ, not only the flow states need to be maintained by each router, but also end-to-end resources need to be reserved for each flow during the lifetime of the connection. IntServ is obviously unsuitable for large scale networks, including the Internet. In such networks, it is difficult for routers to keep track of the large volume of active flows. Resource reservation is also inefficient, especially in under provisioned networks.

The Differentiated Services (DiffServ) architecture [3] has been designed to overcome the scalability problems of IntServ. DiffServ is a macro-level approach. In DiffServ, flows are assigned to classes and each class gets a different level of service. However, there is no differentiation between flows within the same class, except for the drop precedence. As a result, many fairness problems have been observed and discussed in published literature. These include fairness between TCP and UDP flows sharing the same class, and fairness between TCP flows with different parameters (window sizes, round-trip times) sharing the same class [4, 5]. In addition, our study has shown that there is unfairness in the bandwidth sharing between UDP flows with disparate packet sizes or arrival rates within the same DiffServ class. While different scheduling mechanisms are employed for managing the queues of different classes, flows within the same class are generally served on a FIFO basis. A large packet waiting in the queue can force many smaller packets to be delayed, which unfairly increases the overall delay of the system.

In this invention, we present a new framework for improving DiffServ performance by providing a higher degree of fairness and lower average delay. Our approach provides additional refinement to the existing Diffserv classification scheme to separate flows with comparable characteristics into subclasses within the same DiffServ class.

2. Overview of the Differentiated Services Architecture

Diffserv [3] was introduced in the late 1990s in response to the need for a simple, yet effective QoS mechanism suitable for implementation on the Internet. It was realized that the IntServ was too extreme an alternative to the best effort service. In other words, there was a need for a solution that can do a little better than the best effort, while providing a higher level of scalability and simplicity than IntServ [6]. DiffServ achieves scalability by pushing the complexity to the edge of the network where the number of flows is in the range of tens or hundreds, leaving simpler functions to core routers that handle large volumes of traffic flows in the range of hundreds of thousands.

2.1 Classification and Router Operation

DiffServ utilizes 6 bits of the 8-bit Type Of Service (TOS) field of the IP header [7]. This allows up to 64 possible classes. In DiffServ, this field is referred to as Differentiated Service Code Point (DSCP) or forwarding class. Some DSCP values are reserved for different purposes. DiffServ standards define two types of per hop behaviours (PHBs): Expedited Forwarding (EF) [8], and Assured Forwarding (AF) [9]. EF is the highest priority traffic. Packets marked with EF PHB should be forwarded at a higher or at least equal rate as its arrival rate. AF defines four classes with three drop precedence levels for each class.

Edge routers perform two main functions, traffic classification and traffic conditioning, also known as admission control. Both functions are governed by the Service Level Agreement (SLA). Generally, packets conforming to SLA are considered in-profile and packets exceeding SLA are considered out-profile. The classification process examines incoming packets at the ingress router against the rules defined by SLA. Packets are assigned the appropriate class (EF—Expedited Forwarding—or one of the AF—Assured Forwarding—classes) by marking them with the corresponding DSCP field value. The conditioning process ensures that flows stay within the SLA. Depending on flow characteristics and network conditions, out-profile packets are either marked with higher drop precedence, delayed in the queue or dropped [6]. A commonly used admission control technique is the Token Bucket algorithm [10].

With complexity pushed to edge routers, core routers have simpler functions in DiffServ. PHB actions are defined for each class. The router merely checks the DSCP field and performs the appropriate action. Queue management and scheduling techniques are used at both edge and core routers.

2.2 DiffServ Deficiencies in Handling Heterogeneous Traffic

Despite its success as a scalable QoS architecture, DiffServ suffers from some deficiencies that have been identified in published literature. In particular, several fairness problems have been pointed out [11-15]. These problems fall under two categories, inter-class fairness and intra-class fairness [12]. Inter-class fairness refers to the fair share of resources (queue size and bandwidth) between different AF classes. It also includes the sharing of excess bandwidth when the network is underutilized. Some studies have shown that flows in a higher class can get worse performance than flows in lower class due to unbalanced distribution of bandwidth [13]. Intra-class fairness refers to the fair sharing of resources between different flows in the same AF class. Flow-based QoS cannot be guaranteed because DiffServ routers do not keep track of individual flows. In heterogeneous networks, different types of flows may share the same DiffServ class, e.g., TCP flows with different window sizes, a mix of TCP and UDP flows, or UDP flows with different average packet sizes. In these and other scenarios, some flows will gain higher bandwidth than others, although they have the same service priority.

The main cause of intra-class fairness problems is the aggregate nature of DiffServ. This type of unfairness may be unavoidable because of the nature of DiffServ. However, some of these problems can be alleviated using efficient scheduling mechanisms.

3. Related Work

The fairness problems in DiffServ have been addressed in several studies. In [15], a solution is proposed for providing fair sharing of excess bandwidth for traffic flows in proportion to their in-profile rates. The proposed solution classifies flows into Aggregate Groups (AG) based on a fairness index which is calculated based on the number of arrived packets and the specified profile packets of each flow. The aggregation is done at a level that is higher than the flow level but lower than the AF class level. However, this approach uses labels instead of the DSCP field to classify flows. This adds more complexity and incompatibility problems. Also, the proposed solution creates a completely new classification mechanism rather than building on the existing AF classification. The typical number of aggregates (as used in the simulation) is relatively high compared to the number of AF classes.

In [12], two schemes are proposed for providing fairness in DiffServ. For core routers, a scheduling mechanism called Fair Weighted Round Robin (FWRR) is proposed for providing inter-class fairness between out-profile AF packets and Best Effort (BE) packets to prevent either one from unfairly monopolizing resources. This is done by dynamically allocating the bandwidth and queue limits for each class. For edge routers, an intra-class fairness policy is designed to protect responsive flows from greedy non-responsive flows within the same class. However, the intra-class fairness is only provided at edge routers. Also, these schemes do not consider the fairness between multiple UDP flows with different packet size.

In under-provisioned DiffServ network, flows in a lower class might get better performance than flows in a higher class because of the unbalanced distribution of bandwidth when the higher class has a larger number of flows than the lower class. This problem has been addressed in [13]. The paper proposes a technique that estimates the number of active flows in each class and uses this number to dynamically adjust the bandwidth allocated to each class. Each core router examines the source and destination address for each packet in order to apply a hash function that estimates the number of flows, which adds more complexity to the implementation. In addition, the intra-class fairness is not considered.

The fairness between stream and non-stream flows has been studied in [16]. The paper has focused on the problem of negative interactions between TCP and UDP flows sharing the same AF class. Instead of assigning TCP and UDP flows to different classes with dynamic bandwidth allocation, the authors have proposed a new technique that assigns the TCP flows to different classes based on their arrival rate, duration and bandwidth needed. UDP flows are then dynamically assigned to any of the four classes with admission control considering certain parameters. The problem with this approach is that it doesn't provide AF services. The criteria for class assignment are based on application and flow characteristics and not on the SLA or customer assigned priorities.

The fairness between flows with different packet sizes has been studied in [14]. A closed loop signaling feedback technique is proposed which uses fairness information sent from the egress DiffServ router to the ingress DiffServ router to control flow admission to the DiffServ network. This approach does not involve core routers. Thus, core routers fairness may not be improved and no information from core routers is being used to improve the fairness at the edge routers. When there are multiple destinations for a single source, the complexity of this approach is increased limiting the scalability of this approach in large networks. In addition, signaling information is being sent using the EF class, adding an overhead to the network and reducing the throughput of premium EF traffic.

From the previous discussions, the published studies related to the area of fairness in DiffServ either do not consider the intra-class fairness problem between flows with different packet sizes, or use complex techniques to handle this problem. The motivation of our study is similar to the main purpose of DiffServ: Instead of using an approach that adds a lot of overhead to achieve substantial improvement, it is more practical to add minimal overhead to achieve moderate improvement. We show, however, that the improvement with the small overhead can be substantial.

### SUMMARY OF THE INVENTION

In one aspect, the present invention is directed to a method of controlling the order of packets forwarded by an edge router. Initially, packets are received from a network. Then, the packets are assigned into an assured forwarding class and then separated into subclasses such that the packets in each subclass have a comparable characteristic. The comparable characteristic can be the length of the packets (e.g., the number of bytes in the packet).

The method can also include the step of forwarding the packets within the subclasses such that more packets are forwarded from one subclass relative to another subclass. For example, when the comparable characteristic is the length of the packets (e.g., the number of bytes in the packet), equal numbers of bytes can be forwarded from each subclass whereby a subclass having shorter packets forwards a larger number of packets.

In another aspect, the present invention is directed to an edge router to control the order of processing packets. The edge router is provided with an input port, an AF classifier, and an RAF refiner/subclassifier. The input port is adapted to receive packets from a first network. The AF classifier is adapted to assign the packets into an assured forwarding class, and the RAF refiner/subclassifier is adapted to assign the packets into subclasses such that the packets in each subclass have a comparable characteristic, such as the length of the packets and/or an average packet length.

The edge router can also be provided with a conditioner adapted to forward the packets within the subclasses such that more packets are forwarded from one subclass relative to another subclass and a scheduler having a plurality of queues or buffers to receive the packets and then to forward the packets to a transmission line or a network.

For example, when the comparable characteristic is the length of the number of bytes within the packets, the conditioner can be adapted to forward equal numbers of bytes from each subclass whereby a subclass having shorter packets forwards a larger number of packets. In yet another aspect, the present invention is directed to a method of controlling the order of packets forwarded by an edge router. In this method, packets are received from a network, and then assigned into a plurality of assured forwarding classes where the assured forwarding classes have different levels of service. For at least two of the assured forwarding classes, the packets of the assured forwarding class are separated into subclasses such that the packets in each subclass have a comparable characteristic.

In another aspect, the packets within the subclasses are forwarded for the at least two AF classes such that more packets within one subclass of an AF class are forwarded relative to another subclass within the same AF class.

In yet another embodiment, the present invention is directed to an edge router to control the order of processing packets. The edge router includes an input port, an AF classifier, and an RAF refiner/subclassifier. The input port adapted to receive packets from a first network. The AF classifier is adaped to assign the packets into at least two assured forwarding classes, and the RAF refiner/subclassifier is adapted to assign the packets into subclasses for each of the at least two assured forwarding classes such that the packets in each subclass within an assured forwarding class have a comparable characteristic.

In yet a further aspect, the edge router can be provided with a conditioner adapted to forward the packets within the subclasses such that more packets are forwarded from one subclass of an assured forwarding class relative to another subclass within the same assured forwarding class, and a scheduler having a plurality of queues or buffers to receive the packets and then to forward the packets to a transmission line or a network.

### BRIEF DESCRIPTION OF THE SEVERAL VIEWS OF THE DRAWINGS

So that the above recited features and advantages of the present invention can be understood in detail, a more particular description of the invention, briefly summarised above, may be had by reference to the embodiments thereof that are illustrated in the appended drawings. It is to be noted, however, that the appended drawings illustrate only typical embodiments of this invention and therefore not to be considered limiting of its scope, for the invention may admit to other equally effective embodiments.

FIG. 1 is a block diagram illustrating an overview of an exemplary Refined Assured Forwarding Classification System constructed in accordance with the present invention.

FIG. 2A is a block diagram of an exemplary DiffServ core router constructed in accordance with the present invention.

FIG. 2B is a block diagram of an exemplary DiffServ edge router constructed in accordance with the present invention.

FIG. 2C is a block diagram of a network topology used in simulations of the Refined Assured Forwarding Classification System.

FIG. 3 is a graph illustrating simulation results—average delay per packet for the combined flows.

FIG. 4 is a graph illustrating simulation results—number of packets delivered.

FIG. 5 is a graph illustrating simulation results—throughput for individual flows in dataset 2.

FIG. 6 is a graph illustrating simulation results—packet loss comparison.

### DETAILED DESCRIPTION OF THE INVENTION

### 1. The Refined Assured Forwarding Framework

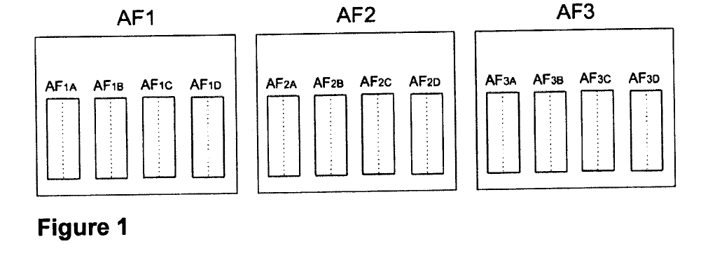

In previous studies [17, 18], the inventors have shown that the performance of heterogeneous networks can be enhanced by dividing flows with similar characteristics into groups rather than aggregating or fully segregating them. This approach brought in a considerable degree of refinement over the integration versus segregation studies reported previously [19, 20]. In this invention, we propose a framework based on a similar concept to alleviate the intra-class unfairness within an AF DiffServ class. We term this approach a Refined Assured Forwarding or RAF framework. The basic idea in the RAF framework is to provide an additional layer of classification independent of the DiffServ classification criteria. Within each AF class, flows are further classified into groups based on their average packet size. This classification can be, for example, done by edge routers, where flows can be tracked. For core routers, the additional classification layer is transparent, except for increasing the number of queues. In order to minimize the impact of the additional classification, the number of groups or secondary level classes should be kept minimal. This can be done, for example, by decreasing the number of AF classes and the number of drop precedence levels to compensate for the increasing number of queues managed by core routers. An overview of the RAF framework is shown in FIG. 1. Each of the three AF classes: AF1, AF2 and AF3 are divided into four RAF subclasses: A, B, C and D. The RAF subclasses for the AF class AF1 are labeled as AF_{1A}, AF_{1B}, AF_{1C}, and AF_{1D}. The RAF subclasses for the AF class AF2 are labeled as AF_{2A}, AF_{2B}, AF_{2C}, and AF_{2D}. The RAF subclasses for the AF class AF3 are labeled as AF_{3A}, AF_{3B}, AF_{3C}, and AF_{3D}. Each subclass preferably supports two drop precedence levels.

### 1.1 Classification Method

In the RAF framework, classification within each AF class is based on a comparable characteristic such as the average packet size or length of the packets in bytes. From FIG. 1, AF class AF₁ is classified into AF_{1A}, AF_{1B}, AF_{1C} and AF_{1D}. Ideally, classification can be performed upon packet arrival by assigning it to the appropriate subclass based on the individual packet size, independent of the flow to which the packet belongs. However, AF specifications do not allow splitting a single flow between multiple classes because this will result in packets arriving out of order [9]. Therefore, it is preferred to make the classification on the flow level instead of on the packet level and maintain a table with flow id/average packet size pairs at the edge routers. The table can be updated by monitoring flows periodically. Typically, flows will have minimal, if any, change of their parameters during the connection lifetime. With this assumption, flow based classification can be simplified

### 1.2 Class Assignment Example

The DiffServ Code Point (DSCP) can be a 6-bit field. This allows up to 64 different class assignments. Two classes are already assigned to the Best Effort (BE) and Expedited Forwarding (EF) classes. This leaves 62 classes for AF. However, standard addressing conventions and addresses reserved for experimental or future use may restrict the use of the available address space. The implementation of RAF may modify the standard way of assigning AF DSCP values. To make the number of queues manageable, we propose using only three AF classes (gold, silver and bronze) with four RAF subclasses in each class as shown in FIG. 1. Within each RAF subclass, two drop precedence levels can be supported. The total number of distinct DSCP values is preferably 24. Note that the distinct DSCP values for drop precedence maybe considered as virtual queues, rather than physical queues. Thus, the actual number of queues managed by core routers is only 12 in this case. RAF subclasses within each AF class are preferably assigned DSCP values that are lower than the next AF class. This is to ensure that subclasses within a lower priority AF class don't get better treatment than higher priority AF classes. RAF subclasses are assigned by the edge router.

In the RAF framework, each of the subclasses has a priority value used for forwarding the packets within the subclasses out of the queues for transmission to a transmission line or a network. In a preferred embodiment, each packet is separated into a particular RAF subclass depending upon the length of the packet. In this embodiment, an RAF subclass for longer packets is given a lower priority than an RAF subclass for shorter packets. By in essence giving shorter packets a higher priority, average transmission delays for the packets is substantially reduced. A weighted fair queuing scheme can be utilized, for example, for determining priorities and for forwarding packets out of the queues of the scheduler for transmission to a transmission line or a network.

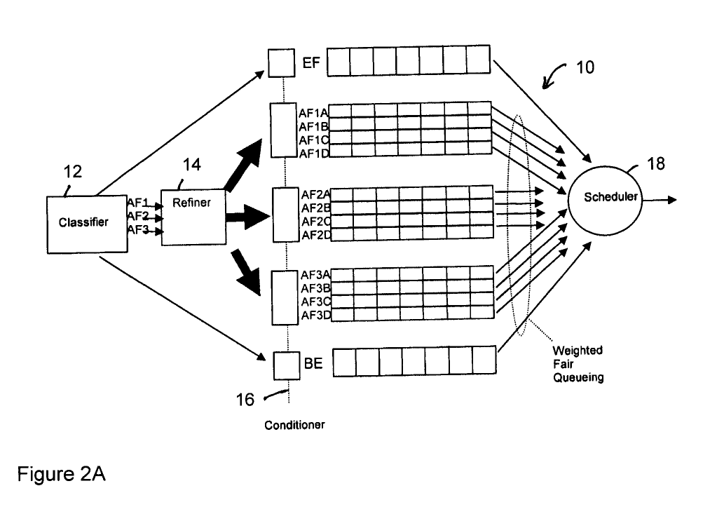

Shown in FIG. 2A is a block diagram of an edge router 10 constructed in accordance with the present invention. The edge router 10 is provided with an AF classifier 12, an RAF refiner/subclassifier 14, a conditioner 16, and a scheduler 18 having a plurality of queues or buffers labeled as EF, AF_{1A}, AF_{1B}, AF_{1C}, and AF_{1D}, AF_{2A}, AF_{2B}, AF_{2C}, and AF_{2D}, AF_{3A}, AF_{3B}, AF_{3C}, and AF_{3D}, and BE. The AF classifier 12 and the conditioner 16 can be a conventional AF classifier 12 and a conditioner 16 utilized in a prior edge router. The RAF refiner/subclassifier 14 changes the flow of packets between the AF classifier 12 and the conditioner 16 of the edge router 10 in accordance with the RAF framework described herein. For example, the RAF refiner/subclassifier 14 can change the flow of packets between the AF classifier 12 and the conditioner 16 by separating the packets into RAF subclasses and then forwarding the packets to the conditioner 16 based upon a priority value for a plurality of RAF subclasses within an AF class. The conditioner 16 checks the packets for compliance with service agreements, for example, and then forwards the packets to the scheduler 18 for forwarding to a network or transmission line.

### 1.3 Core Router Operation

Shown in FIG. 2B is a block diagram of a core router 30 constructed in accordance with the present invention. The core router 30 is provided with an RAF classifier 32 and a scheduler 34. The scheduler 34 is provided with a plurality of queues or buffers labeled as EF, AF_{1A}, AF_{1B}, AF_{1C}, and AF_{1D}, AF_{2A}, AF_{2B}, AF_{2C}, and AF_{2D}, AF_{3A}, AF_{3B}, AF_{3C}, and AF_{3D}, and BE which function as described herein.

In use, the RAF classifier 32 receives the flow of packets from a transmission line (or network), and then assigns the packets to an AF class and also an RAF subclass using the RAF framework described herein. The packets are then passed to the scheduler 34 which places the packets into the plurality of queues based upon the AF class and RAF subclass. In the RAF framework, the core routers 30 may have the flexibility to assign a separate queue for each RAF subclass or to assign RAF subclasses to the same queue as their parent AF class. This enables the implementation of the RAF framework in core routers 30 with different traffic loads and across multiple DiffServ domains. Moreover, the core router 30 can be programmed to choose to combine some of the RAF subclasses into one queue. Table 1 shows a sample database that the core router 30 may maintain in RAF implementation. The first and second columns in Table 1 are for illustrative purposes and need not be stored in the database. The third and fourth columns show suggested DSCP values to identify individual AF classes and their RAF subclasses. P1 and P2 are the two drop precedence levels within each RAF subclass. The fifth column shows the queue number assigned by the core router 30 to flows belonging to the corresponding DSCP. The last column is percentage of the number of incoming packets from the corresponding RAF subclass within its parent AF class. Depending upon the implementation of the core router 30, it can be used to decide whether to assign this subclass a separate queue or combine it with another subclass into the same queue.

It should be understood that the processes described herein, in accordance with the invention, can be performed with the aid of a computer system running a processing algorithm. The processing algorithm runs on one or more processors, which can be a microprocessor, a digital signal processor, a microcontroller, or the like. A router, such as the edge router 10 or the core router 30 may have multiple processors that can run the processing algorithm. The processing algorithm and/or the resulting data from the processing algorithm can be stored on one or more computer readable mediums. Examples of a computer readable medium include an optical storage device, a magnetic storage device, an electronic storage device or the like. The term “Computer System” as used herein means a system or systems that are able to embody and/or execute the logic of the processes described herein. The processor in the router typically runs a proprietary operating system. The logic embodied in the form of software instructions or firmware may be executed on any appropriate hardware which may be a dedicated system or systems, or a general purpose computer system, or distributed processing computer system, all of which are well understood in the art, and a detailed description of how to make or use such computers is not deemed necessary herein. When the computer system is used to execute the logic of the processes described herein, such computer(s) and/or execution can be conducted at a same geographic location or multiple different geographic locations. Furthermore, the execution of the logic can be conducted continuously or at multiple discrete times. Further, such logic can be performed about simultaneously with the implementation of RAF, or thereafter or combinations thereof.

TABLE 1
Example core router database in RAF implementation.

| AF | RAF | DSCP | | Queue | % of Arriving |
|---|---|---|---|---|---|
| Class | Subclass | P1 | P2 | Number | Packets |
| AF1 | A | 001000 | 001001 | 1 | 20% |
| AF1 | B | 001010 | 001011 | 2 | 25% |
| AF1 | C | 001100 | 001101 | 3 | 30% |
| AF1 | D | 001110 | 001111 | 4 | 25% |
| AF2 | A | 010000 | 010001 | 5 | 30% |
| AF2 | B | 010010 | 010011 | 6 | 5% |
| AF2 | C | 010100 | 010101 | 6 | 45% |
| AF2 | D | 010110 | 010111 | 7 | 20% |
| AF3 | A | 011000 | 011001 | 8 | 10% |
| AF3 | B | 011010 | 011011 | 8 | 15% |
| AF3 | C | 011100 | 011101 | 8 | 15% |
| AF3 | D | 011110 | 011111 | 8 | 60% |

### 1.3.1 Queue Management

AF specifications mandate that the implementation of AF uses an active queue management mechanism to minimize long term buffer congestion while allowing short term burstiness [9]. The commonly used queue management technique in DiffServ implementations is Random Early Detection (RED) [21]. RED uses two thresholds, minimum threshold and maximum threshold. When the queue size is below the minimum threshold, no packets are marked for drop. When the queue size is between the minimum threshold and the maximum threshold, packets are randomly marked with linearly increasing probability. When the queue size is beyond the maximum threshold, packets are marked. This gradual dropping behaviour helps to eliminate synchronised congestion that can happen with abrupt dropping, where TCP connections back off and simultaneously start increasing their window size using the Slow Start algorithm, causing congestion scenario to repeat. In RED, packets are dropped approximately proportionally to their connection's share of bandwidth [21].

In DiffServ routers implementing RED for the AF group, each AF class has its own minimum and maximum thresholds. The proposed RAF implementation will preferably use the queue size threshold for the parent AF class as a total. This queue size will be shared among the RAF subclasses. Several of buffer sharing techniques have been proposed in the literature. They range from Complete Partitioning (CP), where each queue is assigned a strict threshold, to Complete Sharing (CS), where queues share the entire buffer space [22-24]. A key parameter for the success of RAF is effective management of the AF queue sharing among the RAF subclasses. This is essential in order to prevent greedy flows with large packet sizes from dominating the use of the buffer. We choose the Push-Out with Threshold (POT) technique for buffer management for example[23]. In POT, a threshold is set for each queue within the buffer. When the buffer is not full, it is fully shared between the queues. When the buffer is full and a new packet arrives, the threshold of its queue is checked. If the queue is beyond its threshold, the new arriving packet is dropped. If the queue is below its threshold, a packet is dropped (pushed out) from the head of the longest queue. The drop precedence preferably is taken into consideration. Packets with lower drop precedence should never be dropped in favour of packets with higher drop precedence.

### 1.3.2 Scheduling and Bandwidth Allocation

In addition to the queue management scheme, the RAF framework relies on efficient scheduling to improve the delay and throughput performance. The RAF framework is essentially a scheduling enhancement technique. Scheduling mechanisms control the amount of time each queue is being serviced. Examples of scheduling mechanisms are Round Robin (RR) [25], Weighted Round Robin (WRR), Deficit Round Robin (DRR) [26], Fair Queueing (FQ) and Weighted Fair Queueing (WFQ) [27, 28]. FQ attempts to emulate time division multiplexing on the packet level by using clock sequencing and time stamping. WFQ adds to FQ the ability to assign different weights to different flows [10].

In the RAF framework, it is desired to increase the throughput and reduce the delay for the flows within the same AF class. To achieve this, the router, such as the core router 30 or the edge router 10 can forward more short packets than long packets at the time of congestion. Therefore, the RAF framework preferably uses WFQ with weights assigned by the edge router 10 to each subclass according to the number of flows in this subclass. The next section provides simulation results of the RAF implementation.

### 2. Simulation Results

To demonstrate the performance enhancement provided by implementation of the RAF framework, several simulation experiments have been performed. The performance is measured on three criteria: average delay per packet, packet drop rate and throughput. FIG. 2C shows the simulation setup used in the simulation experiments. Eight source nodes are connected to a DiffServ edge router (E1). Each source has a UDP agent attached to it. One sink (null) agent is attached to the destination node (Dest). The destination node is attached to a DiffServ edge router (E2). One DiffServ core router (Core) preferably links the two edge routers E1 and E2. Simulations have been done using the Network Simulator ns-2 [29].

To study the effect of scheduling on the performance of the RAF framework, we used WFQ scheduler on the edge router E1 and the core router “Core”. The edge router E1 and the core router “Core” implemented ds/RED queue provided by Nortel DiffServ module [30]. The WFQ module was obtained from [31]. The edge router E2 used a simple DropTail FIFO queue. The weights assigned to the RAF subclasses were proportional to the number of flows in each subclass at the edge router E1. In the core router “Core”, the subclasses were assigned equal weights, as it is assumed that DiffServ core routers do not generally keep track of individual flows. To make a fair comparison between our RAF framework and the regular DiffServ AF operation, the network parameters were identical in RAF and AF simulations, except for the classification provided by the RAF framework with weights assigned to each RAF subclass. In the AF single class, one WFQ queue was used in both edge routers E1 and E2 and the core router “Core”.

In this example, one UDP agent is attached to each source (S1 to S8). Throughout the 30 second duration of each simulation experiment, each source (S1 to S8) generated a single flow. Table 2 shows the five different datasets used in the simulation experiments. In Table 2, C is the link capacity in Mbps, ρ is the link utilization, λ is the arrival rate in packets per second and L is the average packet size in bytes per packet. Pareto distribution [32] was used for both interarrival and packet size distributions to produce self-similar flows [33]. The simulations were performed under two scenarios. Since the purpose of the simulation is to study the intra-class fairness performance, the standard scenario used only one AF class for the flows. In the second scenario, we implemented the four RAF subclasses. Table 3 presents the classification of flows into the RAF subclasses based on their source-destination addresses.

In the results comparison below, the results obtained by our RAF framework are referred to simply as “RAF.” Similarly, the results of regular DiffServ AF implementation are referred to as AF.

TABLE 2
Input data used in the simulations.

| | | | Dataset 1 | | Dataset 2 | | Dataset 3 | | Dataset 4 | | Dataset 5 | |
|---|---|---|---|---|---|---|---|---|---|---|---|---|
| | C | | λ | L | λ | L | λ | L | λ | L | λ | L |
| src | Mbps | ρ | pkt/s | B/pkt | pkt/s | B/pkt | pkt/s | B/pkt | pkt/s | B/pkt | pkt/s | B/pkt |
| S1 | 1 | 0.70 | 1750 | 50 | 1750 | 50 | 1750 | 50 | 1750 | 50 | 1750 | 50 |
| S2 | 1 | 0.70 | 1591 | 55 | 1591 | 55 | 1591 | 55 | 1591 | 55 | 1591 | 55 |
| S3 | 1.5 | 0.75 | 469 | 300 | 282 | 500 | 141 | 1000 | 71 | 2000 | 47 | 3000 |
| S4 | 1.5 | 0.75 | 427 | 330 | 266 | 530 | 157 | 900 | 75 | 1900 | 44 | 3200 |
| S5 | 1.5 | 0.75 | 447 | 315 | 256 | 550 | 118 | 1200 | 64 | 2200 | 43 | 3300 |
| S6 | 2 | 0.80 | 250 | 800 | 167 | 1200 | 67 | 3000 | 34 | 6000 | 23 | 9000 |
| S7 | 2 | 0.80 | 241 | 830 | 143 | 1400 | 58 | 3500 | 31 | 6500 | 22 | 9500 |
| S8 | 3 | 0.90 | 169 | 2000 | 85 | 4000 | 34 | 10000 | 23 | 15000 | 19 | 18000 |

TABLE 3
Flow classification in the simulations.

| Source | Destination | AF class | RAF subclass |
|---|---|---|---|
| S1 | Dest | AF1 | A |
| S2 | Dest | AF1 | A |
| S3 | Dest | AF1 | B |
| S4 | Dest | AF1 | B |
| S5 | Dest | AF1 | B |
| S6 | Dest | AF1 | C |
| S7 | Dest | AF1 | C |
| S8 | Dest | AF1 | D |

### 2.1 Delay Performance

To evaluate delay performance, the queues of the edge router E1 and the Core router “Core” (FIG. 2C) were assigned very large buffers to emulate infinite queue lengths. The edge router E1—core router “Core” and core router “Core”—edge router E2 links were assigned a lower bandwidth than the sum of the bandwidth of the links S1-E1 through S8-E1 to force congestion on the edge routers E1 and E2 and the core router “Core”.

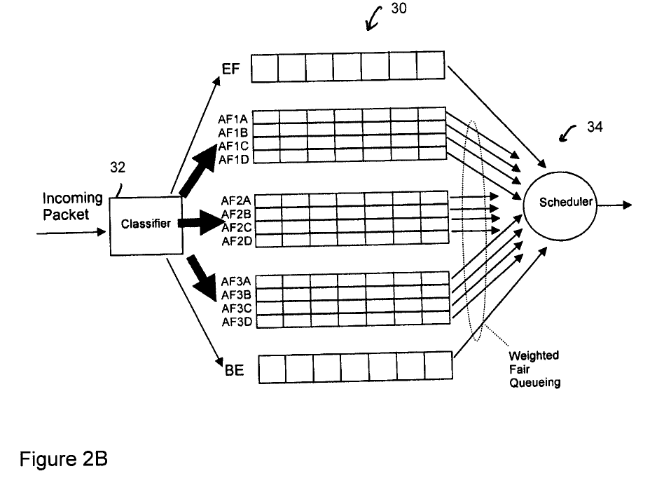

Table 4 presents the average delay per packet that was measured for each individual flow and for the combined traffic. The rows represent each of the flows. The delays with and without the use of our proposed scheme are shown in the RAF and AF columns, respectively, for each of the datasets. From the results, it can be seen that the individual delays are significantly lower for RAF than AF for smaller packet flows. For the combined traffic, the average delay has improved by about 70%. The results are graphically presented in FIG. 3. The results clearly demonstrate the impact of the fair scheduling achieved by the RAF framework.

TABLE 4
Simulation results - delay.
Average Delay Per Packet

| | Dataset | | | | | | | | | |
|---|---|---|---|---|---|---|---|---|---|---|
| | 1 | | 2 | | 3 | | 4 | | 5 | |
| Flow | RAF | AF | RAF | AF | RAF | AF | RAF | AF | RAF | AF |
| 1 | 0.371 | 3.782 | 0.948 | 4.626 | 1.189 | 4.371 | 0.571 | 2.876 | 0.898 | 3.647 |
| 2 | 0.389 | 3.865 | 0.889 | 4.591 | 1.200 | 4.391 | 0.590 | 2.896 | 0.885 | 3.613 |
| 3 | 0.431 | 3.854 | 1.182 | 4.692 | 1.664 | 4.670 | 2.194 | 3.226 | 1.039 | 3.499 |
| 4 | 0.454 | 3.848 | 1.140 | 4.567 | 1.475 | 4.309 | 2.093 | 3.024 | 1.112 | 3.787 |
| 5 | 0.448 | 3.506 | 1.162 | 4.706 | 1.570 | 4.468 | 2.385 | 3.225 | 1.130 | 4.006 |
| 6 | 4.591 | 3.905 | 4.745 | 4.678 | 5.813 | 4.742 | 3.024 | 3.103 | 7.170 | 6.480 |
| 7 | 4.306 | 3.751 | 4.698 | 4.747 | 7.458 | 5.791 | 3.182 | 3.088 | 5.423 | 4.767 |
| 8 | 9.315 | 3.799 | 10.071 | 8.508 | 8.681 | 5.313 | 6.175 | 3.216 | 6.759 | 3.995 |
| Combined | 0.852 | 3.803 | 1.223 | 4.681 | 1.381 | 4.419 | 0.726 | 2.908 | 0.960 | 3.663 |

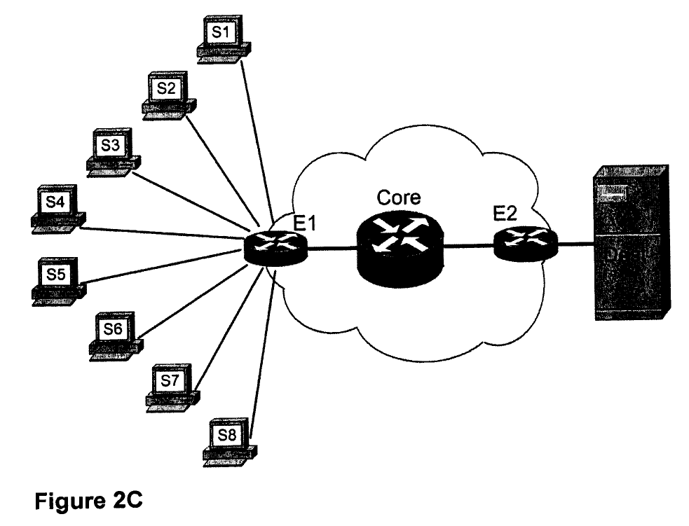

Table 5 presents the number of received packets per flow. The results are graphically presented in FIG. 4. FIG. 4 clearly shows that the number of received packets is significantly higher for the implementation of the RAF framework having the two edge routers E1 and E2 as well as the core router “Core”.

TABLE 5
Simulation results - packet delivery.
Packet Received

| | Dataset | | | | | | | | | |
|---|---|---|---|---|---|---|---|---|---|---|
| | 1 | | 2 | | 3 | | 4 | | 5 | |
| Flow | RAF | AF | RAF | AF | RAF | AF | RAF | AF | RAF | AF |
| 1 | 51643 | 40333 | 46753 | 34322 | 50710 | 39373 | 50969 | 41667 | 50577 | 38907 |
| 2 | 47165 | 36442 | 44385 | 33754 | 43921 | 34508 | 46650 | 37931 | 46361 | 35850 |
| 3 | 12272 | 11058 | 8107 | 6082 | 3526 | 2656 | 2020 | 1857 | 1323 | 986 |
| 4 | 12772 | 10002 | 7812 | 5975 | 4435 | 3458 | 2252 | 2022 | 1324 | 982 |
| 5 | 11416 | 9110 | 7443 | 5621 | 3547 | 2771 | 1762 | 1527 | 1332 | 1049 |
| 6 | 5946 | 6093 | 3599 | 3785 | 1507 | 1595 | 805 | 875 | 445 | 506 |
| 7 | 5320 | 5560 | 2842 | 3064 | 908 | 908 | 703 | 746 | 378 | 463 |
| 8 | 2465 | 3945 | 742 | 1353 | 466 | 739 | 312 | 411 | 292 | 458 |
| Total | 148999 | 122543 | 121683 | 93956 | 109020 | 86008 | 105473 | 87036 | 102032 | 79201 |

### 2.2 Throughput Performance

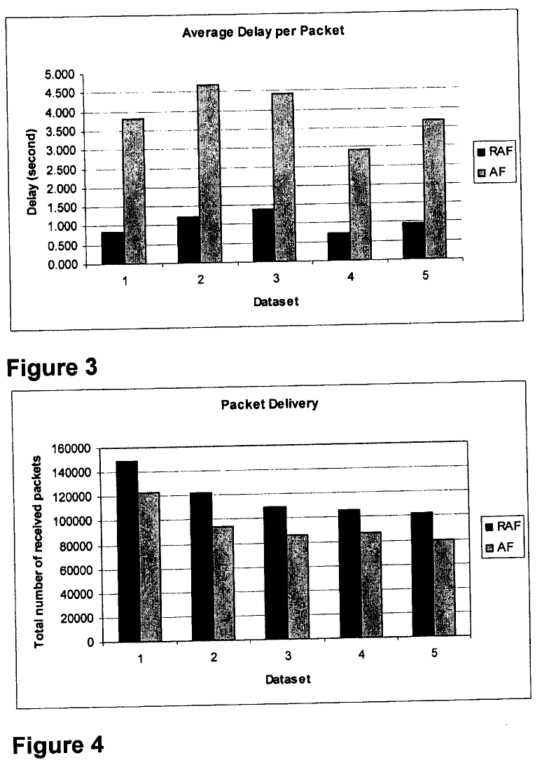

Throughput is the number of bytes received per second from each flow. The throughput performance was evaluated in the same experiments as those used for delay evaluation. Table 6 shows throughputs for individual flows and the total throughput for the combined traffic. FIG. 5 presents the throughput performance of individual flows for dataset 2. While the total throughput is almost the same for RAF and AF in the datasets, it can be seen from FIG. 5 that throughput is more evenly distributed among the flows in RAF than in AF. The proposed scheme thus illustrates not only improvements in delay performance, but also in fairness among traffic flows.

TABLE 6
Simulation results - throughput.
Throughput

| | Dataset | | | | | | | | | |
|---|---|---|---|---|---|---|---|---|---|---|
| | 1 | | 2 | | 3 | | 4 | | 5 | |
| Flow | RAF | AF | RAF | AF | RAF | AF | RAF | AF | RAF | AF |
| 1 | 86215 | 66628 | 78415 | 56335 | 81624 | 63092 | 83402 | 67581 | 83460 | 62923 |
| 2 | 87485 | 66795 | 79260 | 59794 | 80494 | 62034 | 83959 | 67787 | 82872 | 64261 |
| 3 | 115980 | 104755 | 124933 | 93996 | 116270 | 90983 | 132107 | 119355 | 112289 | 84395 |
| 4 | 134402 | 104828 | 134854 | 102357 | 124133 | 95983 | 132999 | 120973 | 130780 | 95957 |
| 5 | 114892 | 89634 | 129092 | 98421 | 131967 | 102980 | 132825 | 116659 | 127018 | 104660 |
| 6 | 154975 | 162093 | 135946 | 143104 | 149452 | 157301 | 147649 | 161186 | 155115 | 179894 |
| 7 | 144656 | 152020 | 130066 | 138546 | 128141 | 128141 | 130874 | 141239 | 131234 | 151828 |
| 8 | 149535 | 241482 | 133276 | 252615 | 141002 | 252558 | 144252 | 194256 | 148998 | 228352 |
| Total | 988139 | 988235 | 945842 | 945170 | 953084 | 953071 | 988068 | 989036 | 971765 | 972270 |

### 2.3 Packet Loss

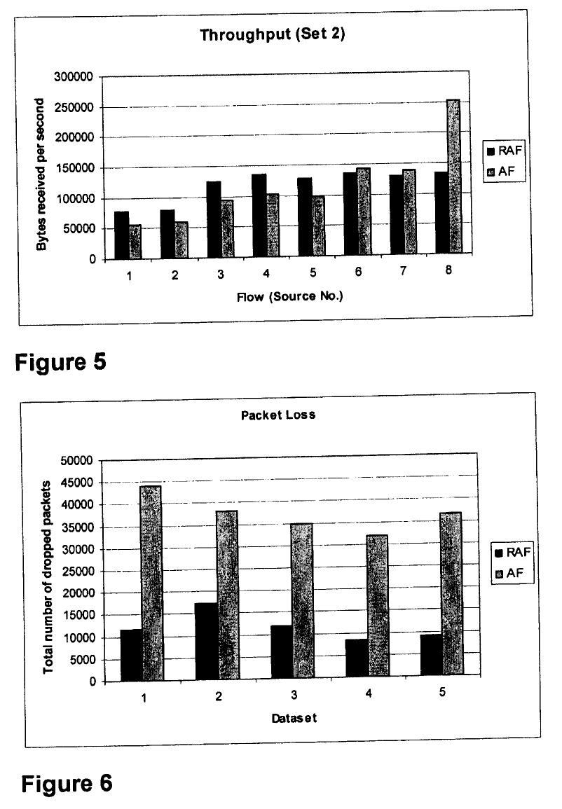

To evaluate the packet loss performance, buffer sizes were decreased in the edge router E1 and the core router “Core”. The other parameters maybe kept identical to the other simulation experiments, including the RED minimum and maximum thresholds. Table 7 and FIG. 6 show the number of dropped packets for individual flows and for the combined traffic, respectively. From Table 7, it can be seen that, without implementing the RAF framework, the number of small packets dropped is much higher than the number of large packets dropped. In addition, the implementation of the RAF framework utilizing the edge routers E1 and E2 and the core router “Core” improved the total packet loss in the combined traffic, as shown in FIG. 6.

TABLE 7
Simulation results - packet loss.
Packet Loss

| | Dataset | | | | | | | | | |
|---|---|---|---|---|---|---|---|---|---|---|
| | 1 | | 2 | | 3 | | 4 | | 5 | |
| Flow | RAF | AF | RAF | AF | RAF | AF | RAF | AF | RAF | AF |
| 1 | 1137 | 15427 | 5248 | 14929 | 4973 | 15868 | 4051 | 15640 | 4744 | 18576 |
| 2 | 950 | 13435 | 4988 | 14091 | 4699 | 14308 | 3846 | 13910 | 4069 | 16167 |
| 3 | 682 | 3668 | 1199 | 2250 | 452 | 1204 | 126 | 580 | 126 | 442 |
| 4 | 443 | 3163 | 1206 | 1906 | 557 | 1265 | 98 | 633 | 90 | 483 |
| 5 | 601 | 3635 | 1047 | 2011 | 349 | 940 | 103 | 480 | 111 | 442 |
| 6 | 2629 | 1660 | 1353 | 1186 | 449 | 481 | 46 | 256 | 16 | 259 |
| 7 | 2401 | 1763 | 1165 | 1162 | 282 | 503 | 56 | 240 | 19 | 82 |
| 8 | 2805 | 1416 | 1138 | 667 | 87 | 228 | 18 | 205 | 11 | 212 |
| Total | 11648 | 44167 | 17344 | 38202 | 11848 | 34797 | 8344 | 31944 | 9186 | 36663 |

### 2.4 Discussion of the Results

The input flows used in the simulation had disparate packet sizes. Without the isolation provided by the RAF framework, flows with large packet sizes, such as S8, dominated the use of the buffer and bandwidth. This caused longer waiting in the queue and less delivery rate for smaller packet flows. When the buffer size was limited, more small packets were dropped in favor of large packets. By using the RAF classification, flows with small packets got a fairer share of resources. With more weight given to RAF subclasses with more flows, the fairness was further enhanced. As a result, the delay, throughput and packet loss of flows with small packets were improved, which also improved the performance of the combined traffic.

### CONCLUSIONS

The Refined Assured Forwarding (RAF) framework, adds at least one additional layer of classification to flows within the DiffServ AF classes based on one or more comparable characteristic of the packets, such as the average packet size in each flow. In a preferred embodiment, the RAF framework uses Weighted Fair Queueing and assigns weights to subclasses proportional to the number of active flows in each subclass at the edge router E1. One or more core routers use a queuing scheme such as Weighted Fair Queueing (WFQ) with equal weights and may combine RAF subclasses or disregard the RAF classification as needed. In the implementation described herein for the RAF framework, more weight is given to queues with more flows. The performance of the RAF framework in terms of average delay, throughput and packet loss has been demonstrated by means of simulations. The simulation results have shown significant improvements for both individual flows and combined traffic.

Although the foregoing invention has been described in some detail by way of illustration and example for purposes of clarity of understanding, it will be obvious to those skilled in the art that certain changes and modifications may be practised without departing from the spirit and scope thereof, as described in this specification and as defined in the appended claims below.

### REFERENCES

[1] U. Payer, “DiffServ, IntServ, MPLS”, www.iaik.tu-graz.ac.at/teaching
[2] R. Mahajan and S. Floyd, “Controlling High Bandwidth Flows at the Congested Router,” AT&T Center for Internet Research ICSI Technical Report TR-01-001, April 2001.
[3] S. Blake, D. Black, M. Carlson, E. Davies, Z. Wang, and W. Weiss, “An Architecture for Differentiated Services,” RFC 2475, December 1998.
[4] C. Kim, Y. Kim, and D. Montgomery, “Fairness-guaranteed per-Class-type Queueing and Hierarchical Packet Scheduling for DiffServ-aware-MPLS Network,” IEEE Globecom 2004, Dallas, Tex., USA, 2004.
[5] L. Dong and M. Robert, “Dynamics of random early detection,” in Proceedings of the ACM SIGCOMM '97 conference on Applications, technologies, architectures, and protocols for computer communication. Cannes, France: ACM Press, 1997.
[6] Z. Wang, Internet QoS Architectures and Mechanisms for Quality of Service. California, USA: Morgan Kuffmann Publishers, 2001.
[7] ISI, “Internet Protocol—DARPA Internet Program Protocol Specification,” RFC 791, January 1981.
[8] V. Jacobson, K. Nichols, and K. Poduri, “An Expedited Forwarding PHB,” RFC 2598, June 1999.
[9] J. Heinanen, T. Finland, F. Baker, W. Weiss, and J. Wroclawski, “Assured Forwarding PHB Group,” RFC 2597, June 1999.
[10] G. Armitage, Quality of Service in IP Networks. Indiana, USA: Macmillan Technical Publishing, 2000.
[11] H. T. Phan and D. B. Hoang, “FICC-DiffServ: A New QoS Architecture Supporting Resources Discovery, Admission and Congestion Controls,” Third International Conference on Information Technology and Applications—ICITA '05, Sydney, Australia, 2005.
[12] Y. Sungwon, D. Xidong, G. Kesidis, and C. R. Das, “Providing Fairness in DiffServ Architecture,” IEEE Global Telecommunications Conference, GLOBECOM '02, 2002.
[13] J.-S. Li and C.-S. Mao, “Providing Flow-based Proportional Differentiated Services in Class-based DiffServ Routers,” IEEE Proceedings on Communications, vol. 151, No. 1, pp. 82-88, 2004.
[14] M. Li and D. B. Hoang, “Resource Discovery and Fair Intelligent Admission Control over Differentiated Services Networks for Variable-Length Packets,” Proceedings of the IEEE 10th Asia-Pacific Conference on Communications, Beijing, China, 2004.
[15] A. Sang, H. Zhu, and S. Li, “Weighted Fairness Guarantee for Scalable DiffServ Assured Forwarding,” IEEE International Conference on Communications—ICC, 2001.
[16] K. Yasukawa, K.-i. Baba, and K. Yamaoka, “Class Assigning Management for Stream Flows Considering Characteristics of Non-stream Flow Classes,” Telecommunications Network Strategy and Planning Symposium. NETWORKS 2004, 11th International, 2004.
[17] M. H. Dahshan and P. K. Verma, “Performance Enhancement by Segregation and Hybrid Integration in General Queueing Networks,” International Symposium on Performance Evaluation of Computer and Telecommunication Systems—SPECTS '05, Philadelphia, Pa., USA, 2005.
[18] M. H. Dahshan and P. K. Verma, “Performance Enhancement of Heavy Tailed Queueing Systems using a Hybrid Integration Approach,” IEEE Global Telecommunications Conference—GLOBECOM '05, St Louis, Mo., USA, 2005.
[19] H. R. Rudin, “On Economies of Scale and Integration of Services in Certain Queued Information Transmission Systems,” IEEE Transactions on Communications, vol. 20, No. 5, pp. 991-995, 1972.
[20] P. K. Verma and A. M. Rybzcynski, “The Economics of Segregated and Integrated Systems in Data Communication with Geometrically Distributed Message Length,” IEEE Transactions on Communications, pp. 1844-1848, 1974.
[21] S. Floyd and V. Jacobson, “Random Early Detection for Congestion Avoidance,” IEEE/ACM Transactions on Networking, vol. 1, No. 4, pp. 397-413, 1993.
[22] F. Kamoun and L. Kleinrock, “Analysis of Shared Finite Storage in a Computer Network Node Environment Under General Traffic Conditions,” IEEE Transactions on Communications, vol. 28, No. 7, pp. 992-1003, 1980.
[23] M. Markaki and I. S. Venieris, “A Novel Buffer Management Scheme for CBQ-Based IP Routers in a Combined IntServ and DiffServ Architecture,” Fifth IEEE Symposium on Computers and Communications—ISCC 2000, Antibes-Juan les Pins, France, 2000.
[24] F. Agharebparast and V. C. M. Leung, “On the Deployment of RED on Shared-Memory Buffers,” IEEE Communications Letters, vol. 6, No. 10, pp. 458-460, 2002.
[25] E. Hahne and R. Gallager, “Round Robin Scheduling for Fair Flow Control in Data Communication Networks,” IEEE International Conference on Communications, 1986.
[26] M. Shreedhar and G. Varghese, “Efficient Fair Queuing Using Deficit Round-Robin,” IEEE/ACM Transactions on Networking, vol. 4, No. 3, pp. 375-385, 1996.
[27] A. Demers, S. Keshav, and S. Shenker, “Analysis And Simulation of a Fair Queueing Algorithm,” ACM SIGCOMM Computer Communication Review, vol. 19, No. 4, pp. 1-12, 1989.
[28] A. K. Parekh and R. G. Gallager, “A Generalized Processor Sharing Approach to Flow Control in Integrated Services Networks: the Single-Node Case,” IEEE/ACM Transactions on Networking, vol. 1, No. 3, pp. 344-357, 1993.
[29] The Network Simulator ns-2″, www.isi.edu/nsnam/ns
[30] J. Ethridge, M. Baines, and F. Shallwani, “A Network Simulator Differentiated Services Implementation,” Open IP, Nortel Networks, 2001.
[31] A. Mrkaic, “Porting a WFQ Scheduler into ns-2's DiffServ Environment,” Student Thesis SA-2001.37, 2001.
[32] V. Paxon, “Empirically Derived Analytic Models of Wide-Area TCP Connections,” IEEE/ACM Transactions on Networking, vol. 2, No. 4, pp. 316-336, 1994.
[33] W. E. Leland, M. S. Taqqu, W. Willinger, and D. V. Wilson, “On the Self-Similar Nature of Ethernet Traffic (Extended Version),” IEEE/ACM Transactions on Networking, vol. 2, No. 1, pp. 1-15, 1994.

What is claimed is:

1. A method of controlling the order of packets forwarded by an edge router, the method comprising the steps of:
receiving packets from a network;
assigning the packets into an assured forwarding class; and
separating the packets of the assured forwarding class into subclasses such that the packets in each subclass have a comparable characteristic.

2. The method of claim 1, wherein in the step of separating, the comparable characteristic is the length of the packets.

3. The method of claim 2, wherein the length of the packets is defined further as the number of bytes in the packet.

4. The method of claim 1, further comprising the step of:
forwarding the packets within the subclasses such that more packets are forwarded from one subclass relative to another subclass.

5. The method of claim 4, wherein in the step of separating, the comparable characteristic is the length of the packets.

6. The method of claim 5, wherein the packets include bytes and also wherein equal numbers of bytes are forwarded from each subclass whereby a subclass having shorter packets forwards a larger number of packets.

7. An edge router to control the order of processing packets, comprising:
an input port adapted to receive packets from a first network;
an AF classifier adaped to assign the packets into an assured forwarding class; and
an RAF refiner/subclassifier adapted to assign the packets into subclasses such that the packets in each subclass have a comparable characteristic.

8. The edge router of claim 7, wherein the comparable characteristic is the length of the packets.

9. The edge router of claim 8, wherein the length of the packets is defined further as the average packet length.

10. The edge router of claim 7, further comprising:
a conditioner adapted to forward the packets within the subclasses such that more packets are forwarded from one subclass relative to another subclass.

11. The method of claim 10, the comparable characteristic is the length of the packets.

12. The method of claim 11, wherein the packets include bytes and also wherein the conditioner is adapted to forward equal numbers of bytes from each subclass whereby a subclass having shorter packets forwards a larger number of packets.
Note: claims 13-24 are similar to claim 1, except there are at least two assured forwarding classes.

13. A method of controlling the order of packets forwarded by an edge router, the method comprising the steps of:
receiving packets from a network;
assigning the packets into a plurality of assured forwarding classes where the assured forwarding classes have different levels of service; and
for at least two of the assured forwarding classes:
separating the packets of the assured forwarding class into subclasses such that the packets in each subclass have a comparable characteristic.

14. The method of claim 13, wherein in the step of separating, the comparable characteristic is the length of the packets.

15. The method of claim 14, wherein the length of the packets is defined further as the average packet length.

16. The method of claim 13, further comprising the step of:
forwarding the packets within the subclasses for the at least two AF classes such that more packets within one subclass of an AF class are forwarded relative to another subclass within the same AF class.

17. The method of claim 16, wherein in the step of separating, the comparable characteristic is the length of the packets.

18. The method of claim 17, wherein the packets include bytes and also wherein equal numbers of bytes are forwarded from each subclass whereby a subclass having shorter packets forwards a larger number of packets.

19. An edge router to control the order of processing packets, comprising:
an input port adapted to receive packets from a first network;
an AF classifier adaped to assign the packets into at least two assured forwarding classes; and
an RAF refiner/subclassifier adapted to assign the packets into subclasses for each of the at least two assured forwarding classes such that the packets in each subclass within an assured forwarding class have a comparable characteristic.

20. The edge router of claim 19, wherein the comparable characteristic is the length of the packets.

21. The edge router of claim 20, wherein the length of the packets is defined further as the average packet length.

22. The edge router of claim 19, further comprising:
a conditioner adapted to forward the packets within the subclasses such that more packets are forwarded from one subclass of an assured forwarding class relative to another subclass within the same assured forwarding class.

23. The method of claim 22, the comparable characteristic is the length of the packets.

24. The method of claim 23, wherein the packets include bytes and also wherein the conditioner is adapted to forward equal numbers of bytes from each subclass whereby a subclass having shorter packets forwards a larger number of packets.
